(19) United States
(12) Patent Application Publication
(10) Pub. No.: US 2007/0064105 A1
(43) Pub. Date: Mar. 22, 2007

(54) Indoor apparatus of intercom system and method for controlling indoor apparatus

(75) Inventors: Tomohiro Ohshima, Fukuoka (JP); Tomohiro Morita, Fukuoka (JP); Takeshi Tanaka, Fukuoka (JP); Naotako Yamamoto, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/472,432

(22) Filed: Jun. 22, 2006

(30) Foreign Application Priority Data
Jun. 24, 2005 (JP) 2005-184297
Feb. 28, 2006 (JP) 2006-051728

(51) Int. Cl. H04N 7/18; H04N 9/47

(52) U.S. Cl. 348/143

(57) ABSTRACT

An intercom apparatus of the present invention includes a display that displays an image captured by an outdoor apparatus having a camera; a database that stores an image of a person and history information of the person; an image authentication unit that compares the image captured by the outdoor apparatus with the image stored in the database; and a controller. When the image authentication unit has compared the image captured by the outdoor apparatus with the image stored in the database and determined that the images are of a same person, the controller displays, on the display, history information corresponding to the image that has been determined to be of the same person and the image captured by the outdoor apparatus.

### BACKGROUND OF THE INVENTION

1. Field of the Invention

The present invention relates to an indoor apparatus utilized for an intercom system and a method thereof.

2. Description of Related Art

As shown in FIG. 11 and FIG. 13, conventional intercom apparatus 101 consists of two apparatuses: outdoor apparatus 102 and indoor apparatus 103, the latter being installed indoor. FIG. 11 is a schematic configuration diagram of a conventional intercom apparatus, and FIG. 13 is a schematic arrangement plan of the conventional intercom apparatus. Outdoor apparatus 102 includes camera 121, ring switch 122, speaker 123 and microphone 124. Camera 121 captures an image of a visitor and outputs an image signal representing the image. Ring switch 122 is for the visitor to operate. Speaker 123 is for the visitor to hear voice from indoor. Microphone 124 is for transmitting the visitor's voice to indoor.

Camera 121 is connected to image display 131 of indoor apparatus 103. An image signal from camera 121 is processed by image display 131, and a face image of the visitor is displayed on a monitor of indoor apparatus 103. Indoor apparatus 103 also includes ring tone signal generator 132, that generates a ring tone signal in response to an operation on ring switch 122. The ring tone signal is amplified by amplifier 133 and a ring tone is output from speaker 134. Response terminal further includes handset 136, that is for performing a conversation in response to the ring tone and is connected to speaker 123 and microphone 124 of outdoor apparatus 102 through amplifier 135. When a person responding to the ring tone picks up handset 136, a conversation circuit is formed between outdoor apparatus 102 and indoor apparatus 103. At the same time, camera 121 and image display 131 are brought into operating conditions.

However, with this conventional intercom apparatus 101, when there was a ring tone, an indoor responding person was not able to identify who has operated ring switch 122, without picking up handset 136 and actually performing a conversation and activating camera 121 and image display 131.

Consequently, a person authentication intercom apparatus has been proposed (see Related Art 1), which includes person database 142 and image recognition unit 141. Person database 142 stores image data of a person who has a possibility to operate ring switch 122 of outdoor apparatus 102. Image recognition unit 141 takes in image data of a person who operated ring switch 122 and compares the image data with the image data stored in person database 142. FIG. 12 is a schematic configuration diagram of the conventional person authentication intercom apparatus. The arrangement of the intercom apparatus of FIG. 12 is the same as that of FIG. 13.

According to intercom apparatus 101, when ring switch 122 is operated, controller 143 activates camera 121, image display 131, image recognition unit 141, and person database 142. Image recognition unit 141 compares visitor's image data transmitted from camera 121 with data stored in person database 142. As a result of comparing the two image data, when the visitor's image data is stored in person database 142, a specific ring tone for a person suited to receiving the visitor is retrieved from ring tone database 144 and output from speaker 134. When the visitor's image data is not stored in person database 142, depending on a setting regarding whether a ring tone is to be generated, a generic ring tone, for example, is generated.

Depending on the result of person authentication, whether to store the person's image data is determined. When it is necessary, the person's image data is stored in person database 142, and data of a ring tone for a person suited to receiving the visiting person is stored in ring tone database 144. Further, it is also possible to update image data stored in person database 142.

However, the above described intercom apparatus 101 of Related Art 1, shown in FIG. 12, has a restriction on the presumable number of people, because of the memory capacity of ring tone database 144 and the like, and also has a problem that, when a ringing method is changed, outdoor apparatus 102 has to be redesigned. Therefore, a technology has been proposed in which, after person authentication is performed by indoor apparatus 103, information regarding a result of the person authentication is transmitted via a separate interface to an externally connected terminal apparatus with a larger memory capacity, such as a cordless phone base unit, where a notification process of the person authentication is performed, and predetermined ring tone information is transmitted to a selected ringing apparatus, such as a cordless phone handset. The ring tone information and the like are stored in a memory of the externally connected terminal apparatus (see Related Art 2).

Technology related to person authentication -has advanced rapidly in recent years. For example, a face recognition technology (for example, Related Art 3), which performs a comparison by using a video image, and a voice comparison technology (for example, Related Art 4), which compares a person by using a voice, have been proposed. In Related Art 3, a Gabor feature obtained from an image and graph matching are used to perform a comparison. A graph is formed by connecting all pairs of feature-extractable points (such as eyes, mouth, and nose) with lines. A graph matching identifies a person by matching the graphs. A Gabor feature is obtained by taking a frequency component, a direction and the like of a feature point from an image, thus extracts individual features. In Related Art 4, a voice section is detected from a voice signal; an acoustic parameter is used to divide the voice section into a plurality of blocks; and a speaker-specific feature quantity is generated and stored for each of the blocks. When a comparison is performed, the feature quantities are compared.

[Related Art 1] Japanese Patent Publication No. 3250797.

[Related Art 2] Japanese Patent Laid Open Publication No. 2000-287196.

[Related Art 3] Published Japanese Translation of PCT Patent Application No. 2002-511617.

[Related Art 4] Japanese Patent Laid Open Publication No. H2-236599

As described above, the person authentication intercom apparatus of Related Art 1 captures image data of a person who operated ring switch 122, and compares the image data with image data stored in person database 142. Therefore, who the operator is can be immediately known, and a person who is best suited to receiving the visitor can receive the visitor.

However, for the person suited to receiving the visitor who operated ring switch 122, it is merely a notification that the visitor has arrived. The person authentication function is not fully utilized. Further, there is a-restriction on the presumable number of people, because of the memory capacity and the like, thus leading to a problem with respect to practical use of the apparatus.

With regard to this point, the intercom apparatus of Related Art 2 stores a person authentication notification processing program and ring tone information in an externally connected terminal apparatus via an interface, thus improving the above-described conventional technology with respect to practical use of the apparatus. However, that a person has been authenticated is still not fully utilized. Basically the same as the above described conventional technology, it is merely a notification to the person suited to receiving the visitor.

Recently, as bonds between people in local community become weakened, safety can no long be taken for granted, and it becomes necessary for each family to protect themselves. An intercom apparatus can help authenticate a person in advance, when it is not limited to being simply a ringing apparatus, but can function to prevent a family from getting involved in trouble, and can be utilized to obtain information regarding a visitor in advance before actually meeting the visitor. There may be also some people, visits from whom all family members prefer to refuse. When such a person is authenticated, it is necessary to issue a refuse-to-respond warning to family members. Further, in many cases, authentication information and related information are constantly changing, so that, when the information is not updated, person authentication accuracy degrades, and past history becomes a deciding factor on whether to meet the visitor.

### SUMMARY OF THE INVENTION

The purpose of the present invention is to provide an indoor apparatus utilized for an intercom system that is capable of identifying a visitor and displaying related information before responding.

To address the above-described problems of the conventional technology and in order to achieve the above-described purpose, the present invention provides an indoor apparatus that includes a display, a memory, an image comparer, and a controller. The display displays an image captured by an outdoor apparatus that has a camera. The memory stores an image of a person and history information of the person. The image comparer compares the image captured by the outdoor apparatus with the image stored in the memory. When the image comparer determines that the image captured by the outdoor apparatus and the image stored in the memory are of the same person, the controller displays, on the display, the history information associated with the image that is determined to be of the same person and the image captured by the outdoor apparatus.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a perspective view of an outdoor apparatus of an intercom apparatus according to a first embodiment of the present invention;

FIG. 2(a) is a perspective view of an indoor apparatus of the intercom apparatus according to the first embodiment of the present invention;

FIG. 2(b) is a front view of a display of the indoor apparatus of the intercom apparatus according to the first embodiment of the present invention;

FIG. 3 is a block configuration diagram of the outdoor apparatus of the intercom apparatus-according to the first embodiment of the present invention;

FIG. 4 is a block configuration diagram of the indoor apparatus of the intercom apparatus according to the first embodiment of the present invention;

FIG. 5(a) is a block diagram of a history controller of the indoor apparatus of the intercom apparatus according to the first embodiment of the present invention;

FIG. 5(b) is a configuration diagram of a database according to the first embodiment of the present invention;

FIG. 6 is a configuration diagram of an individual information section of the database according to the first embodiment of the present invention;

FIG. 7 is a flowchart of an image authentication process of the intercom apparatus according to the first embodiment of the present invention;

FIG. 8 is a block configuration diagram of an indoor apparatus of an intercom apparatus according to a second embodiment of the present invention;

FIG. 9(a) is a block diagram of a history controller of the indoor apparatus of the intercom-apparatus according to the second embodiment of the present invention;

FIG. 9(b) is a configuration diagram of a database according to the second embodiment of the present invention;

FIG. 10 is a flowchart of a voice authentication process of the intercom apparatus according to the second embodiment of the present invention;

FIG. 11 is a schematic configuration diagram of a conventional intercom apparatus;

FIG. 12 is a schematic configuration diagram of a conventional person authentication intercom apparatus; and

FIG. 13 is a schematic arrangement plan of a conventional intercom apparatus.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### First Embodiment

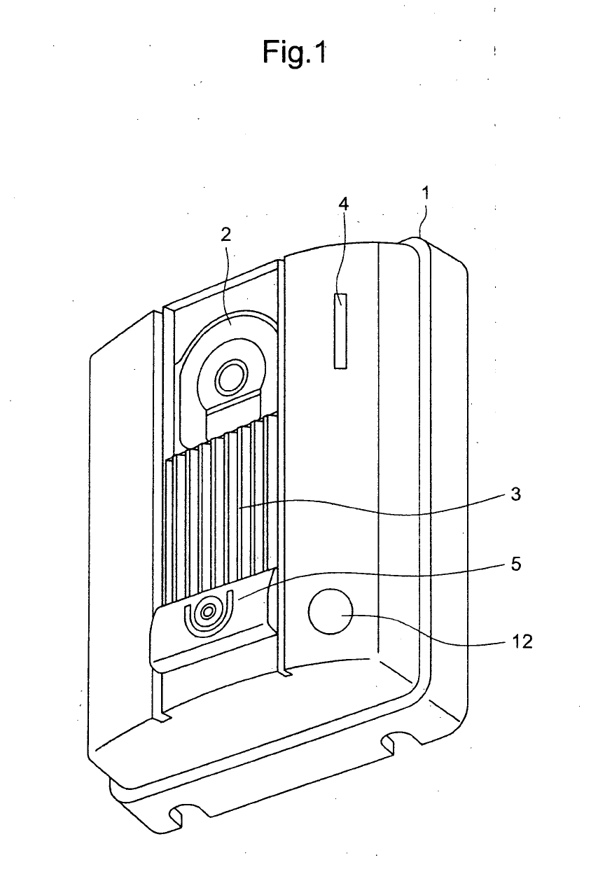

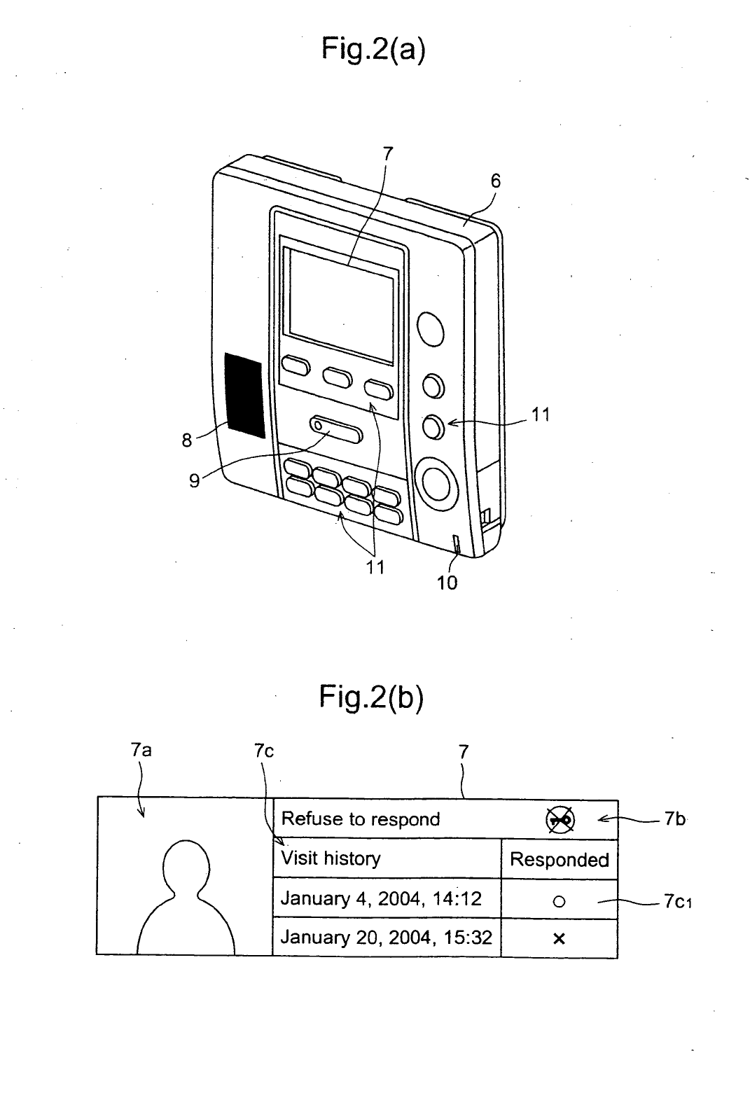

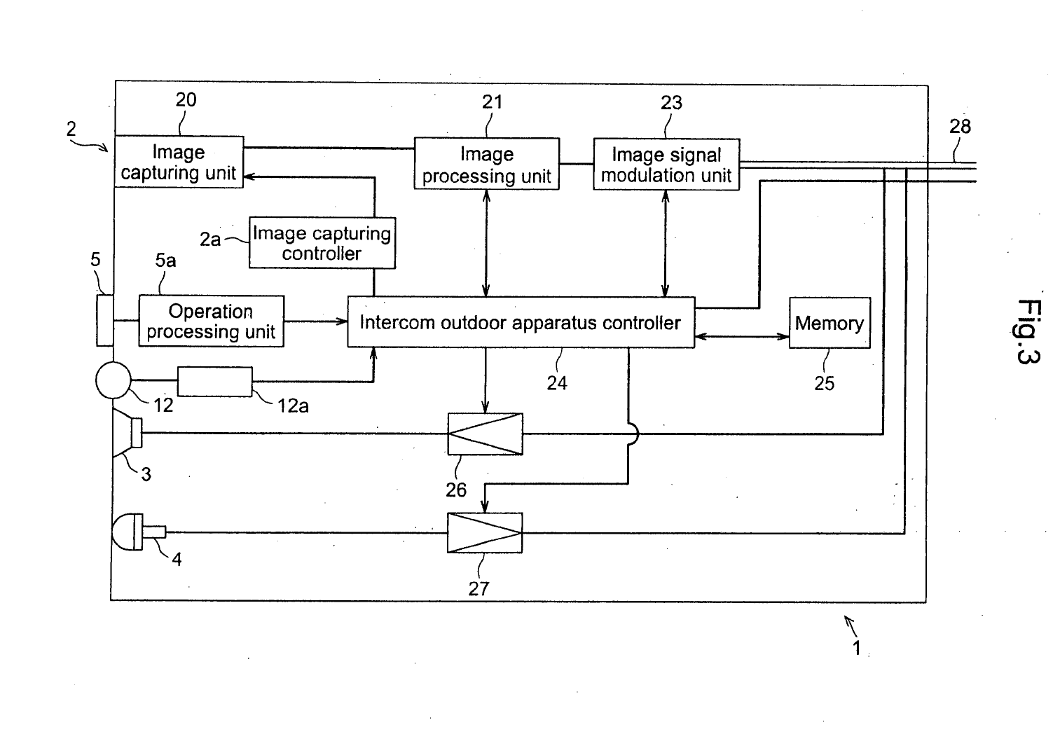

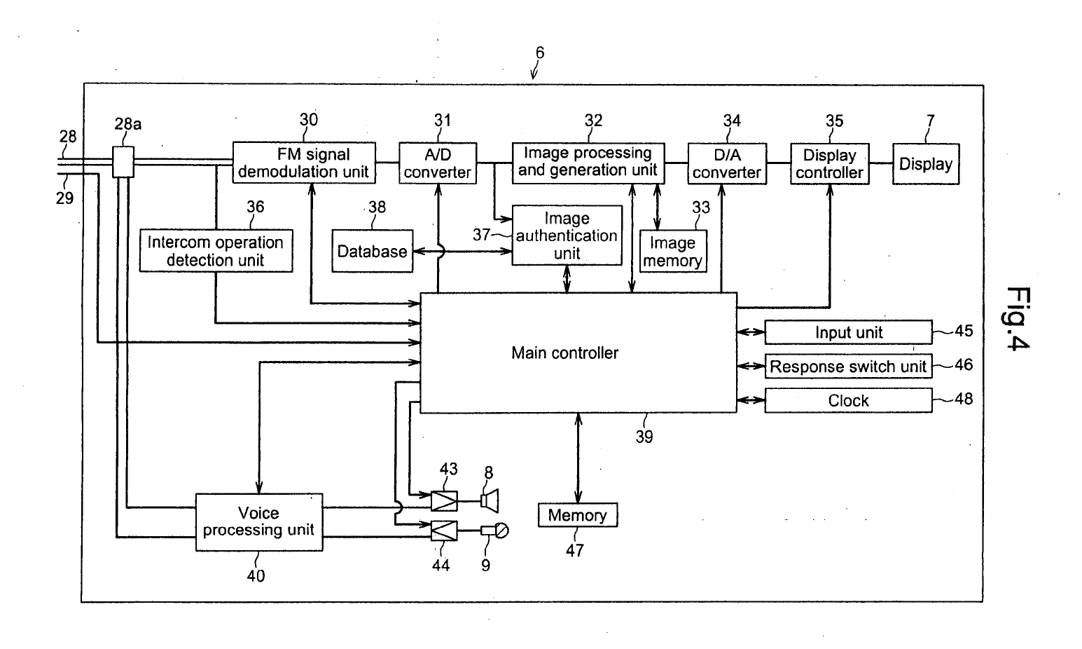

An intercom apparatus of a first embodiment of the present invention performs person authentication using images. FIG. 1 is a perspective view of an outdoor apparatus of the intercom apparatus according to the first embodiment of the present invention. FIG. 2(a) is a perspective view of an indoor apparatus of the intercom apparatus according to the first embodiment of the present invention. FIG. 2(b) is a front view of a display of the indoor apparatus of the intercom apparatus according to the first embodiment of the present invention. FIG. 3 is a block configuration diagram of the outdoor apparatus of the intercom apparatus according to the first embodiment of the present invention. FIG. 4 is a block configuration diagram of the indoor apparatus of the intercom apparatus according to the first embodiment of the present invention.

As FIG. 1 shows, outdoor apparatus 1 of the intercom apparatus according to the first embodiment includes camera 2, speaker 3, microphone 4, operation button 5, and sensor 12. Camera 2, such as a CCD or the like, is provided on the front face of a main body of outdoor apparatus 1. Speaker 3 is provided on the main body of outdoor apparatus 1 for outputting voice, which is input from indoor apparatus 6 (to be described later). Microphone 4 is for inputting voice to outdoor apparatus 1. Operation button 5 is for a visitor to use to initiate a ringing on indoor apparatus 6. Sensor 12 is for detecting a person or the like approaching or passing nearby outdoor apparatus 1 by the person's body temperature.

As shown in FIG. 2(a), indoor apparatus 6 is capable of receiving an image of a visitor's face and the like captured by camera 2 of outdoor apparatus 1 and a voice input from microphone 4 of outdoor apparatus 1, and performing person authentication. Indoor apparatus 6 according to the first embodiment performs person authentication based on an image of a visitor's face and the like. Display 7, which is an LCD or the like, is provided on the front face of indoor apparatus 6. An example of a screen displayed on display 7 is shown in FIG. 2(b). As FIG. 2(b) shows, the screen displayed on display 7 is divided into several areas. Among the areas, image area 7a is for displaying a person's image transmitted from outdoor apparatus 1; warning area 7b warns that a refuse-to-respond has been set for the person displayed on display 7; and visit history area 7c shows past visits by the person displayed on display 7. Visit history area 7c also displays information regarding received/refused visits in the past. As FIG. 2(a) shows, indoor apparatus 6 further includes speaker 8, response switch 9, microphone 10, and input keyboard 11. Response switch 9 is for a user to press when the user decides to respond after looking at the display of display 7. Input keyboard 11 is for inputting a name of a person or a business, a telephone, and an address. Received-or-refused visit information 7c1 is automatically assigned in association with each past visit displayed in visit history area 7c.

Next, configuration of outdoor apparatus 1 according to the first embodiment is explained with reference to FIG. 3. In FIG. 3, image capturing controller 2a controls zooming and the like of image capturing unit 20. Operation processing unit 5a detects when operation button 5 is pressed. Such detection is based on that a pull-up voltage drops rapidly when operation button 5 is ON. Above-described sensor 12 is a pyroelectric sensor or the like. Sensor detection unit 12a detects a signal input from sensor 12. It is also possible to make the voltage drop when sensor detection unit 12a detects a signal input from sensor 12 that has detected a visitor. Image capturing unit 20 is a CCD or the like that constitutes a camera. Image processing unit 21 processes a signal output from image capturing unit 20 and outputs an image signal. Image signal modulation unit 23 performs frequency modulation of the image signal output from image processing unit 21 and outputs an 8.5-10 MHz FM signal.

Outdoor apparatus 1 further includes outdoor apparatus controller 24 and memory 25. Memory 25 stores programs and data. Outdoor apparatus controller 24 of outdoor apparatus 1, of which the hardware consists of a central processing unit (hereafter referred to as CPU), reads in a program from memory 25 or another memory and executes various functions as a software functional realization unit. Amplifiers 26 and 27 amplify outputs of speakers 3 and 4, respectively. First signal line 28 is for transmitting video signals and voice signals to indoor apparatus 6.

In the first embodiment, first signal line 28 consists of two wires. A dc voltage of +22 V is applied to one wire, and the other wire is grounded. In the first embodiment, operation processing unit 5a and doorphone operation detection unit 36, which will be described later, are used to transmit image signals and voice signals through first signal line 28. However, as an alternative method, it is also possible to form a wired LAN or a wireless LAN, which performs communication according to a predetermined protocol, by providing communication controllers on outdoor apparatus 1 and indoor apparatus 6, respectively, and connecting them with networking cables. A-detailed description is omitted.

A human voice, which is usually of 500 Hz-2 kHz, input from microphone 4, is amplified by amplifier 27 and superimposed without modification on the FM signal of 8.5-10 MHz output from image signal modulation unit 23. The superimposed signals are further superimposed by a dc voltage of +22 V and are transmitted through first signal line 28 to indoor apparatus 6. In other words, when in a standby mode, a voltage of +5 V is supplied from indoor apparatus 6 to outdoor apparatus 1. When operation button 5 is pressed under such condition, a rapid voltage drop occurs in first signal line 28 due to an action of operation processing unit 5a; a voltage of +22 V is supplied; and indoor apparatus 6 detects that operation button 5 has been pressed. Thereafter, a voice signal and the above-described FM signal, superimposed by the voltage of +22 V, are transmitted, and indoor apparatus 6 displays an image on display 7. In the case where operation button 5 is pressed when indoor apparatus 6 is in operation, a detection signal is superimposed on a band that does not interfere with the FM signal and-the like, and is transmitted. Indoor-apparatus 6 starts a person authentication process, and, depending on the result of the person authentication process, displays related information, for example, a refuse-to-respond warning in warning area 7b and visit history in visit history area 7c.

Next, a configuration of indoor apparatus 6 is explained with reference to FIG. 4. Symbols 28 and 29 indicate the first signal line and the second signal line, respectively, in FIG. 4. Signal separation unit 28a separates two superimposed signals that are transmitted through first signal line 28, namely the FM signal frequency-modulated by image signal modulation unit 23 and the voice signal which is superimposed on the FM signal. FM signal demodulation unit 30 demodulates the FM signal. A/D converter 31 converts the demodulated analog video signal to a digital signal for the purpose of image processing and image authentication.

Image processing and generation unit 32 performs image processing on the digital video signal converted by AND converter 31 and generates a predetermined image. In the first embodiment, the screen displayed on display 7 shown in FIG. 2(b) is divided, and the image and other related information are separately displayed. This process is performed by image processing and generation unit 32. Image memory 33 stores data such as a template for the screen displayed on display 7. Image processing and generation unit 32 adjusts the size or cuts out a part of the image captured by camera 2 and pastes it to image area 7a of the template, and displays a text message and a symbol showing a refuse-to-respond setting in warning area 7b and text message of visit history in visit history area 7c, thereby generating data for one screen.

D/A converter 34 converts the image-processed digital video signal to an analog signal. Display controller 35 is for displaying a video signal on display 7, and displays an image captured by camera 2 on display 7, which is an LCD or the like. Doorphone operation detection unit 36 detects, on the indoor apparatus 6 side, a visitor's operation when the visitor presses operation button 5 of outdoor apparatus 1. A detection signal is input to main controller 39 (to be described later) and used as a trigger for initiating operations of indoor apparatus 6.

Indoor apparatus 6 according to the first embodiment first displays an image of a visitor's face and the like on display 7 and performs image authentication (image comparison) of the visitor. Here, the word “comparison” means finding out whether two images are of the same person by comparing the images. However, hereafter in the first embodiment, the word “authentication” includes the meaning of allowing entry to the house after “comparison.” Therefore, the configuration of indoor apparatus 6 includes the following. Image authentication unit 37 (the image comparer according to the first embodiment) takes a one-screen image based on a video signal output from AID converter 31, compares the image with a large volume of obtained image data that have been individually accumulated, and performs a person identification process. Database 38 (the memory according to the first embodiment) stores obtained and individually-accumulated image data of past visitors and family members for performing authentication by image authentication unit 37, and also stores individual information associated with the images. In association with each of the obtained images stored in database 38, a name, a camera condition such as a zoom of a camera used to capture the image, settings such as brightness, and target information such as image size and accessories (for example, with or without glasses) are stored.

Image authentication unit 37 matches the above-mentioned conditions with the conditions of the current image, extracts feature-extractable points such as positions and shapes of eyes, nose and mouth, and predetermined positions of bones and the like, measures a distance in feature space between the two images, and determines that the two images are of the same person when the distance in feature space is within a predetermined range. For example, it is possible to use an algorithm in which a Gabor feature and graph matching are used as a comparison method, and a distance is measured to perform a similarity estimation (see Related Art 3). In this case, since person identification is performed by matching graphs formed by connecting pairs of feature-extractable points (eyes, mouth, nose and the like) with lines, the feature points are extracted in advance from obtained images and are stored as data. In order to extract individual features, frequency components and directions of feature points are extracted from an image as Gabor features and are stored. Image authentication unit 37 captures an image from a video, obtains data of a graph and a Gabor feature, and performs a matching with data of feature points of-an obtained and stored image. Whether the images are of the same person can be determined by using such comparison alone. Therefore, comparison with a large number of people can be performed quickly. As will be described later, the obtained images stored in database 38 can be easily updated by pressing an update key on input keyboard 11. Further, there are a large number of methods available for authentication by comparing feature points of an image, such as methods involving comparing human veins or eyes, which can be used as well.

Main controller 39 of indoor apparatus 6, of which the hardware consists of a CPU, reads in a program from memory 47 (to be described later) or another memory and executes various functions as a software functional realization unit. The various functions of the functional realization unit according to the first embodiment will be described later.

Voice processing unit 40 is connected to first signal line 28. Amplifiers 43 and 44 are for speaker 8 and microphone 10, respectively. Voice processing unit 40 controls voice communication, such as detecting an interruption in a voice and conversation switch-over between indoor apparatus 6-and outdoor apparatus 1. Input unit 45 performs inputs by using operation keys of input keyboard 11. Response switch unit 46 starts communication between indoor apparatus 6 and outdoor apparatus 1 by pressing response switch 9. Memory 47 stores programs and data for main controller 39. Clock 48 is used for recording visit history.

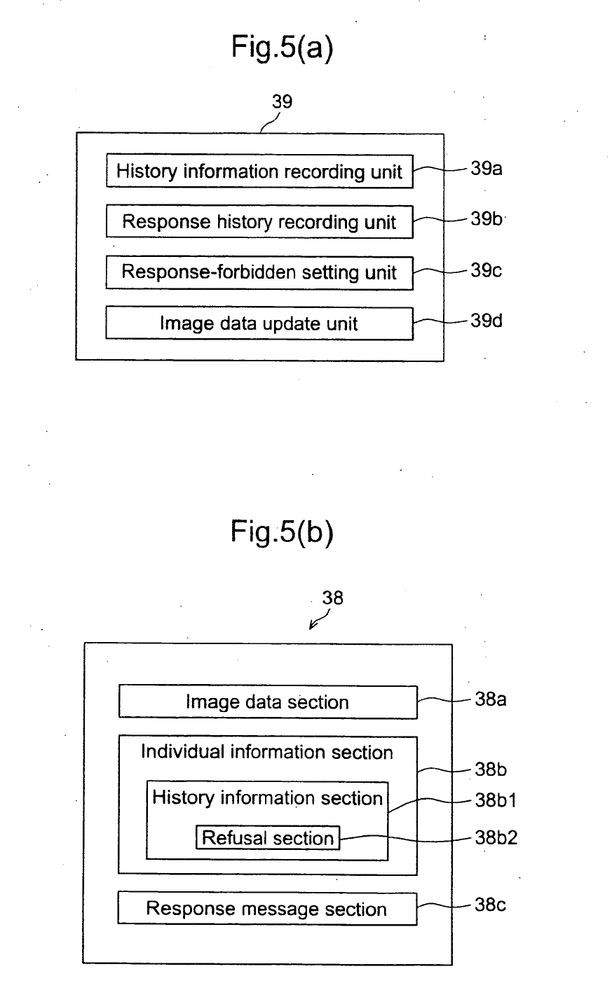

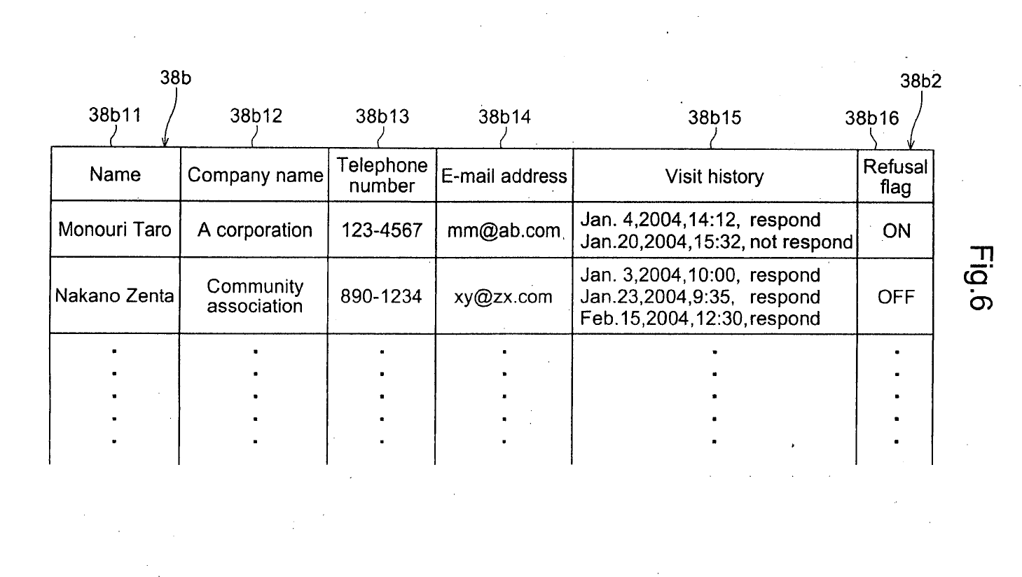

Next, the functional realization unit of main controller 39 according to the first embodiment of the present invention is explained. FIG. 5(a) is a block diagram of a history controller of the indoor apparatus of the intercom apparatus according to the first embodiment of the present invention. FIG. 5(b) is a configuration diagram of a database according to the first embodiment of the present invention. FIG. 6 is a configuration diagram of an individual information section of the database according to the first embodiment of the present invention.

As shown in FIG. 5(a), main controller 39 is provided with the following functional realization unit for processing history information. When there is a visitor, history information recording unit 39a automatically records information related to the visitor who has been image-authenticated, together with the time of clock 48. Response history recording unit 39b records whether a response was made from indoor apparatus 6 for each record in the visit history. There may be some visitors from whom users absolutely want to refuse visits. In such case, response-forbidden setting unit 39c sets a refuse-to-respond setting. Such setting can be easily set by pressing a refuse-to-respond key on input keyboard 11. The refuse-to-respond setting may vary between individuals. When users want to temporarily remove the refuse-to-respond setting for some individual, the refuse-to-respond setting can be easily removed by a long-pressing of the above mentioned refuse-to-respond key. However, the history of such operations are all recorded as history by response history recording unit 39b. Further, the person who pressed the refuse-to-respond key and the person who temporarily removed the setting are also recorded and can be displayed in warning area 7b.

Image data update unit 39d is executed when a user wants to update the image data stored in database 38 to the latest image data. As described above, image update can be performed by pressing the update key on input keyboard 11. An automatic function is set by, for example, a long-pressing of the update key, and in this case, image update can be performed whenever there is a visit. Further, a data correction unit (not shown in the drawing) can be used to correct/change visit history and individual information that have been input with errors, by using keys for such purposes.

FIG. 5(b) shows an internal configuration of database 38. Image data section 38a stores image data and a feature parameter of the image in association with its individual information including name and the like. Individual information section 38b records individual information including name and the like. History information section 38b₁ records visit history. Refusal section 38b₂ of history information section 38b₁ sets a refusal flag when the refuse-to-respond key is pressed. Response message section 38c is provided for responding by playing a predetermined message instead of responding in person. In response message section 38c, messages shared by the whole family, such as “We are currently away from home,” as well as individual messages, such as “Let's meet at the school club,” are stored. A desired message is transmitted without pressing response switch 46, by selecting an automatic-response key of input keyboard 11.

FIG. 6 shows the details of individual information section 38b. In FIG. 6, name 38b₁₁ of a visitor is associated with obtained image data. Company name 38b₁₂ indicates the visitor's affiliation. Telephone number 38b₁₃ indicates an telephone number at a contact address; and e-mail address 38b₁₄ indicates an e-mail address. These are input by using character input keys of input keyboard 11.

Visit history 38b₁₅ records all visits made by a visitor in the past in chronological order. For example, “H16, 01, 04, 1.4, 12, respond” means that “the person visited on Jan. 4, 2004 (H16) at 14:12, and was responded to.” On the other hand, the record “H16, 01, 20, 15, 32, not respond” means that “the person visited on Jan. 20, 2004 (H16) at 15:32, and was not responded to.” These data are automatically recorded by response history recording unit 39b. Refusal flag 38b₁₆ is set in refusal section 38b₂ by response-forbidden setting unit 39c by pressing the refuse-to-respond key of input keyboard 11. These data are all associated with the name of the image-authenticated person and are displayed, by using a template, in visit history area 7c of display 7 shown in FIG. 2(b), with the refusal flag being displayed in-warning area 7b. In the first embodiment, these data are input by using input keyboard 11. However, it is also possible to make display 7 a touch panel or a GUI display. For example, instead of pressing the refuse-to-respond key, it is also possible to make a refusal-flag button of warning area 7b shown in FIG. 2(b) an input-capable active display and temporarily remove the setting by touching the active display.

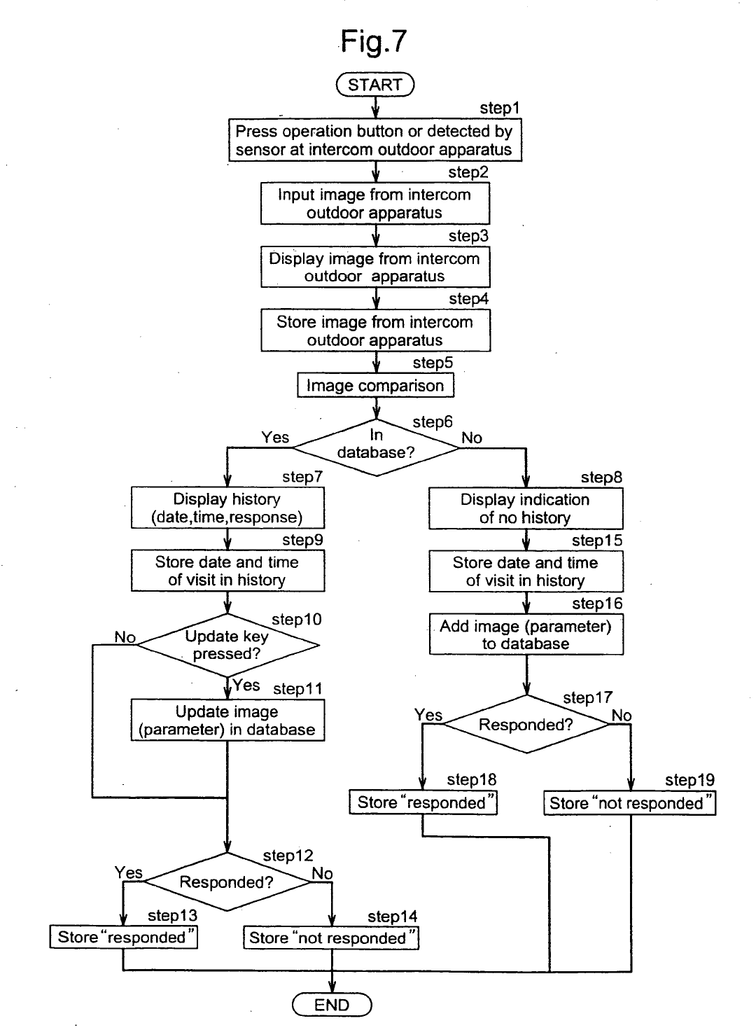

Next, the above mentioned operations of the intercom apparatus according to the first embodiment are explained with reference to a flowchart shown in FIG. 7. FIG. 7 is a flowchart of an image authentication process of the intercom apparatus according to the first embodiment of the present invention. First, at the outdoor apparatus, either a visitor presses the operation button or the sensor detects the visitor (step 1). The outdoor apparatus performs an image input by transmitting an image to the indoor apparatus (step 2). The indoor apparatus displays the image (step 3) and stores the image (step 4).

Thereafter, the indoor apparatus compares image information of the image with image information stored in the database by comparing pairs of the feature points (step 5), and determines whether the image information is in the database (step 6). Image information includes obtained image data and a parameter of a feature point. In case where the image information is in the database, history including date and time and response status of each visit is displayed (step 7). In case where the image information is not in the database, an indication that there is no history is displayed (step 8).

History is displayed in step 7 in the case of a revisit. In this case, after displaying the history, the indoor apparatus saves the date and time of the visit into the history information section as history (step 9) and determines whether the update key was pressed (step 10). In the case where the update key was pressed, the indoor apparatus updates image information, namely, the obtained image data and the parameter of the feature point, in the database (step 11).

After the image information update in step 11, or in the case where the update key was not pressed in step 10, the indoor apparatus determines whether a responding person actually responded to the visitor (step 12), and stores in the history an indication that a response was made in the case where the responding person responded to the visitor (step 13), or an indication that a response was not made in the case where the responding person did not respond to the visitor (step 14).

In the case where an indication that there is no history is displayed in step 8, the indoor apparatus saves, after displaying the indication, the date and time of the visit into the history information section as history (step 15), and adds the image information, namely, the obtained image data and the parameter of the feature point, to the database (step 16). Thereafter, the indoor apparatus determines whether a responding person actually responded to the visitor (step 17). In other words, the indoor apparatus stores in the history an indication that a response was made in the case where the responding person responded to the visitor (step 18), or an indication that a response was not made in the case where the responding person did not respond to the visitor (step 19). By the above-described operations, it is possible to automatically obtain information about the visitor before actually meeting the visitor.

As described above, when there is a visitor, the intercom apparatus according to the first embodiment of the present invention identifies the visitor through image authentication, and displays relevant information including name, company name, telephone number and the like, and visit history information. Therefore, it is possible to prevent trouble by looking at the display. Since solid information about the visitor can be obtained before actually meeting the visitor, response to the visitor can be easily and quickly handled. Further, there are also-some-people, visits from whom all family members prefer to refuse. In such a case, a warning can be issued to the family in advance. It is also possible to automatically update the authentication information.

### Second Embodiment

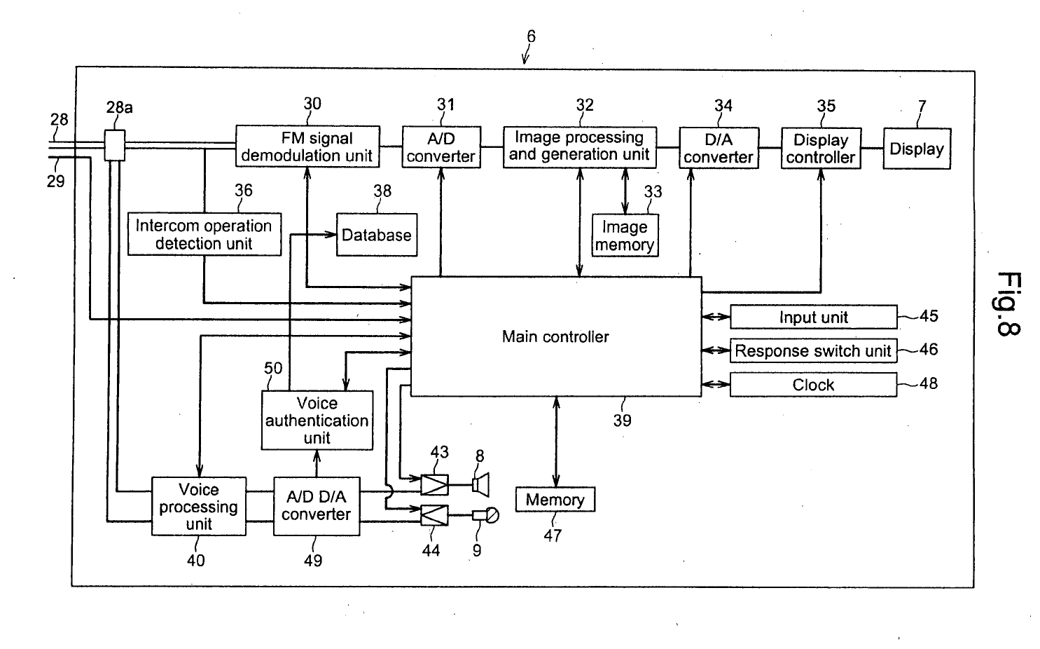

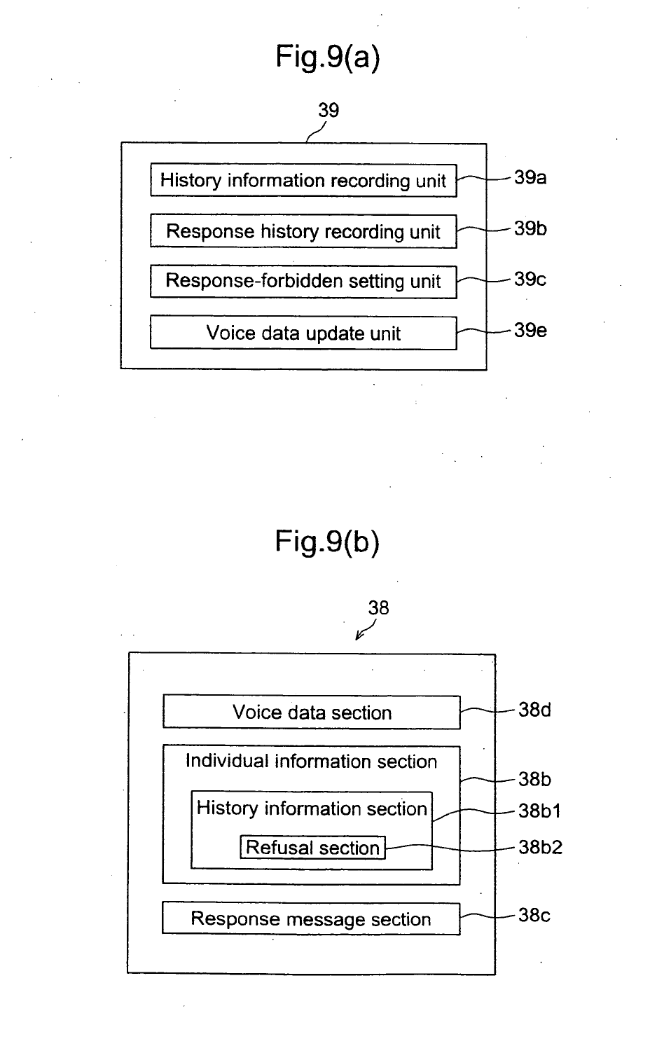

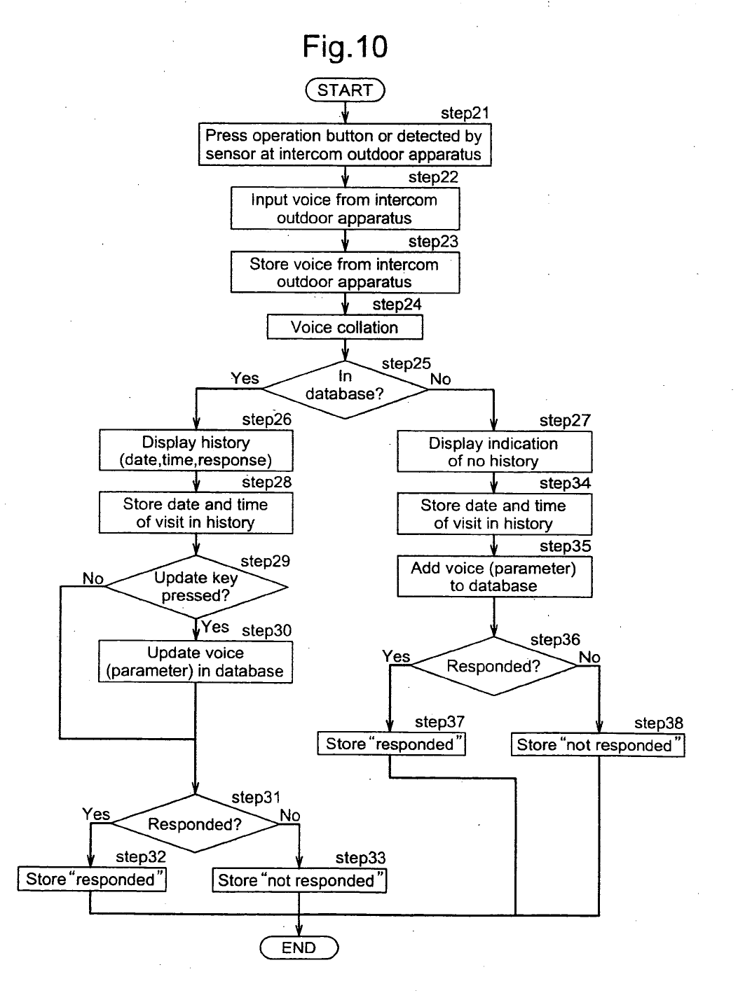

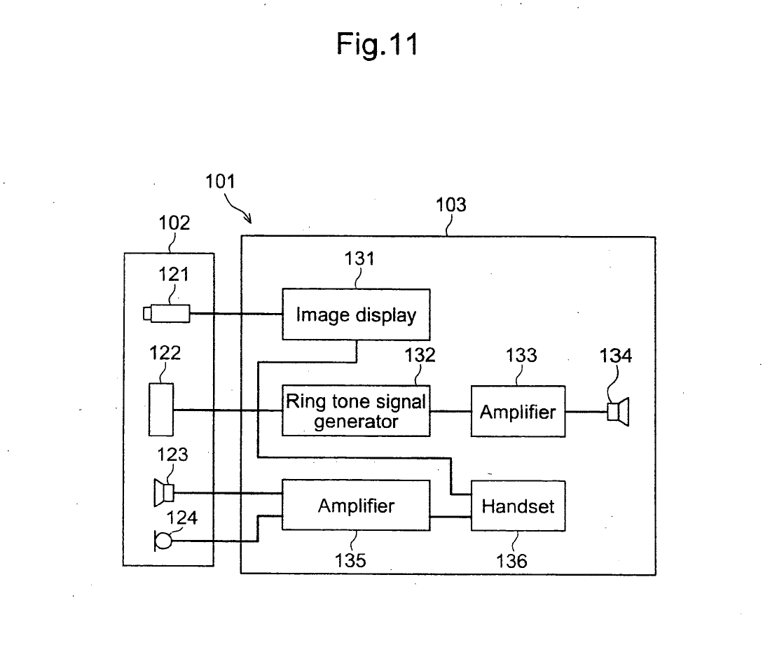

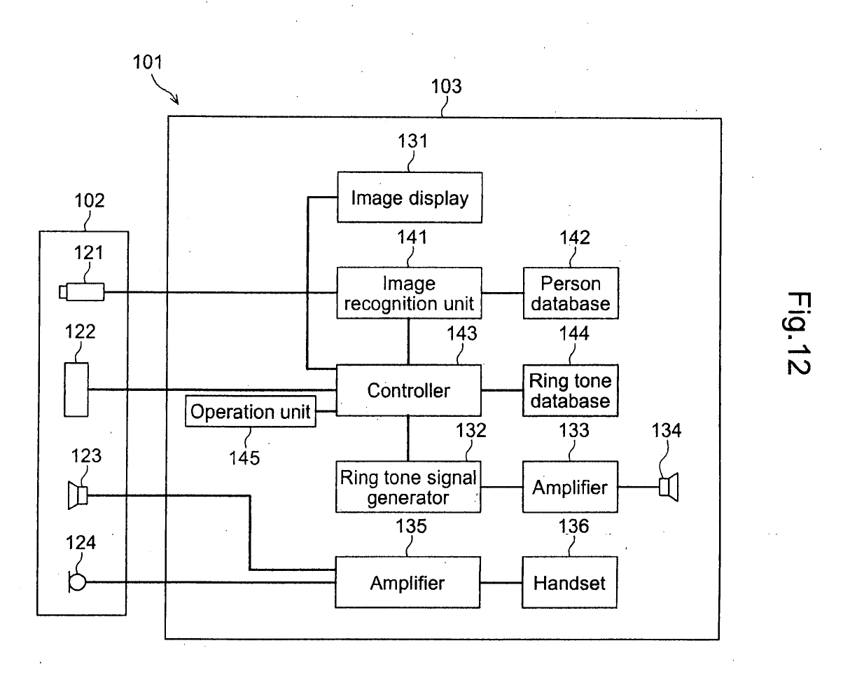

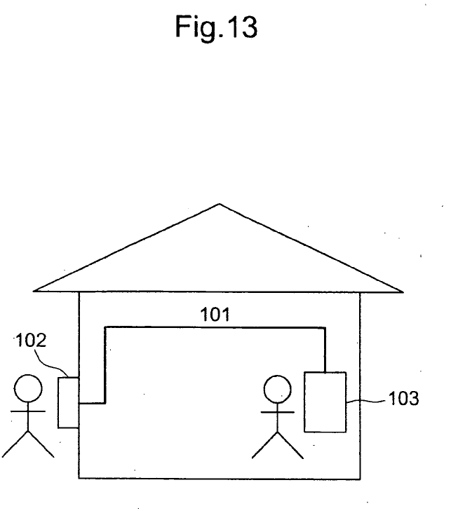

An intercom apparatus according to a second embodiment of the present invention performs person authentication using voices. FIG. 8 is a block configuration diagram of an indoor apparatus of the intercom apparatus according to the second embodiment of the present invention. FIG. 9(a) is a block diagram of a history controller of the indoor apparatus of the intercom apparatus according to the second embodiment of the present invention. FIG. 9(b) is a configuration diagram of a database according to the second embodiment of the present invention. FIG. 10 is a flowchart of a voice authentication process of the intercom apparatus according to the second embodiment of the present invention. The intercom apparatus according to the second embodiment and the intercom apparatus according to the first embodiment have basically the same configuration, and the same symbols are used to denote the same components and their descriptions are omitted.

A/D D/A converter 49 shown in FIG. 8 encodes a voice signal input from microphone 4 of outdoor apparatus 1 or from microphone 10 and passes the digital data to voice authentication unit 50 (to be described later) for spectral analysis and the like, and, thereafter, decodes the data and outputs the data to voice processing unit 40 or speaker 8. Voice authentication unit 50 (a speaker comparer according to the second embodiment) takes samples from the digital voice signal output from A/D D/A converter 49, extracts feature points and performs person authentication. Here, the meanings of the words “comparison” and “authentication” are the same as in the first embodiment described above.

As well known, each person's voice spectrogram is individually different. Each individual's feature points are extracted by converting a voice section input from microphones 4 and 10, such as a voice signal “Mr. Somebody,” “Excuse me,” or “is this Mr. Somebody's residence?” to a digital signal and by analyzing the voice section. The individual feature points are compared with feature points of obtained voice data stored beforehand. A distance in feature space of the two voice data is measured, and the two voices are presumed to be of the same person when the distance in feature space is within a predetermined range. In this case, the feature points of obtained voice data are stored as data in advance.

Extraction of feature points, for example, can be performed as follows (see Related Art 4). Voice processing unit 40 detects a voice section of a voice signal based on an interruption in the voice (a silent section is determined by using power, rate of change of spectrum, pitch, and the like), and obtains an acoustic parameter of the voice section by obtaining numerous spectrum time-series data from an A/D-converted signal by using a band-pass filter group, and by converting the A/D-converted signal to a cepstrum coefficient representing a spectrum through window-mounting by using a Hamming window or the like. Voice authentication unit 50 divides the voice section into a plurality of blocks by using the obtained acoustic parameter, and generates a speaker-specific feature quantity for each block, such as, in the case of spectrum time-series data, an average along a time direction in the block. Such feature quantities are obtained from obtained data and are stored in advance. When a comparison is performed, a stored feature quantity is compared with a detected feature quantity.

As described above, voice authentication unit 50 compares feature points extracted from blocks of an input voice section with the feature points stored in advance. By using such comparison alone, whether the voices are of the same person can be determined. Therefore, comparison with a large number of people can be performed quickly. Similar to the images of the first embodiment, the obtained voice data stored in database 38 (the memory unit of the second embodiment) can be easily updated by pressing the update key on input keyboard 11. Further, there are a large number of methods available recently for extracting and comparing feature points for voice authentication, such as Fast Fourier Transform (FFT) and Line Spectrum Pair (LSP), which can be used as well.

In FIG. 9(a), voice data update unit 39e is executed when a user wants to update the obtained voice data stored in database 38 to the latest voice data. As already described above, the voice data update can be performed by pressing the voice update key on input keyboard 11. An automatic function is set by a long-pressing of the voice update key. In this setting, voice data can be updated whenever there is a visit.

In FIG. 9(b), voice data section 38d, which is provided in database 38, stores obtained voice data and feature parameters of the voice data in association with the visitor's name. The content of individual information section 38b is identical to that of the first embodiment and its description is omitted.

In the second embodiment, voice authentication unit 50, voice data update unit 39e and voice data section 38d are provided. However, it is not impossible to provide them in parallel with image authentication unit 37, image data update unit 39d and image data section 38a of the first embodiment. Providing the two in parallel helps improve authentication accuracy. In this case, for example, after image authentication is performed by image authentication unit 37, a voice authentication is performed by voice authentication unit 50, and the person is identified only when a distance in feature space is within a predetermined threshold. The image and voice authentication processes can also be executed in reversed order.

Next, operations of the intercom apparatus according to the second embodiment are explained with reference to a flowchart of FIG. 10. First, at the outdoor apparatus, either a visitor presses the operation button or the sensor detects the visitor (step 21). The outdoor apparatus performs a voice input by transmitting a voice signal to the indoor apparatus (step 22). The indoor apparatus stores the voice signal (step 23).

Thereafter, the indoor apparatus compares voice information of the voice signal with voice information stored in the database by comparing pairs of the feature points (step 24), and determines whether the voice information is in the database (step 25). Voice information includes obtained voice data and a parameter of a feature point (namely, a feature quantity). In the case where the voice information is in the database, history including date and time and response status of each visit is displayed (step 26). In the case where the voice information is not in the database, an indication that there is no history is displayed (step 27).

History is displayed in step 26 in the case of a revisit. In this case, after displaying the history, the indoor apparatus saves the date and time of the visit into the history information section as history (step 28) and determines whether the update key was pressed (step 29). In the case where the update key was pressed, the indoor apparatus updates voice information, namely, the obtained voice data and the parameter of the feature point, in the database (step 30).

After the voice information was updated in step 30, or in the case where the update key was not pressed in step 29, the indoor apparatus determines whether a responding person actually responded to the visitor (step 31), and stores in the history an indication that a response was made in the case where the responding person responded to the visitor (step 32), or an indication that a response was not made in the case where the responding person did not respond to the visitor (step 33).

In the case where an indication that there is no history is displayed in step 27, after displaying the indication, the indoor apparatus saves the date and time of the visit into the history information section as history (step 34), and adds the voice information, namely, the obtained voice data and the parameter of the feature point, to the database (step 35). Thereafter, the indoor apparatus determines whether a responding person actually responded to the visitor (step 36). In other words, the indoor apparatus stores in the history an indication that a response was made in the case where the responding person responded to the visitor (step 37), or an indication that a response was not made in the case where the responding person did not respond to the visitor (step 38). By the above-described operations, it is possible to automatically obtain information about the visitor before actually meeting the visitor.

Compared to the intercom apparatus according to the first embodiment, for which when image-capturing environmental condition changes, the data changes to some extent as well, and there is also a possibility that accessories such as glasses may prevent an authentication process. However, voice authentication by the above described intercom apparatus according to the second embodiment is better suited to such environmental conditions, and is also simpler than image authentication.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application Nos. 2006-051728 and 2005-184297 filed on Feb. 28, 2006 and Jun. 24, 2005, respectively, entire contents of which are expressly incorporated by reference herein.

What is claimed is:

1. An indoor apparatus connected to an outdoor apparatus for an intercom system, the indoor apparatus comprising:
a display that displays an image captured by the outdoor unit, the outdoor unit including a camera;
a memory that stores an image of a person and history information related to the person;
an image comparer that compares the image captured by the outdoor unit with the image of the person stored in the memory; and
a controller that, when the image comparer determines that the image captured by the outdoor apparatus is substantially equal to the image of the person stored in the memory, displays, on the display, the captured image and the history information related to the person.

2. The indoor apparatus according to claim 1, wherein, when the image comparer determines that the images are not substantially equal the controller displays, on the display, predetermined information indicating that there is no visit history.

3. The indoor apparatus according to claim 1, comprising a clock that times a date and a time of a visit, wherein, when the image comparer determines that the images are substantially equal, the controller further displays, on the display, the history information including dates and times of visits.

4. The indoor apparatus according to claim 3, wherein the date and time of the visit comprises when the image captured by the doorphone unit is displayed on the display.

5. The indoor apparatus according to claim 1, wherein the memory stores response history regarding whether a response was made to a visit; and, when the image comparer determines that the images are substantially equal, the controller further displays, on the display, history information including the response history.

6. The indoor apparatus according to claim 1, wherein the memory stores a feature parameter obtained from an image captured by the outdoor apparatus; and the image comparer compares a feature parameter obtained from an image captured by the outdoor apparatus with the feature parameter stored in the memory.

7. An indoor apparatus connected to an outdoor apparatus for an intercom system, the indoor apparatus comprising:
a display that displays history information of a person corresponding to a voice input by the outdoor apparatus, the outdoor apparatus including a microphone;
a speaker that outputs the voice input by the outdoor apparatus;
a memory that stores a voice of a person and history information related to the person;
a speaker comparer that compares the voice input by the outdoor apparatus with the voice stored in the memory; and
a controller that, when the speaker comparer determines that the voices are substantially equal, displays, on the display, the history information related to the person corresponding to a voice input by the outdoor apparatus.

8. The outdoor apparatus according to claim 7, wherein, when the speaker comparer determines that the voices are not substantially equal, the controller displays, on the display, predetermined information indicating that there is no visit history.

9. The outdoor apparatus according to claim 7, comprising a clock that times a date and a time of a visit, wherein, when the speaker comparer determines that the voices are substantially equal, the controller further displays, on the display, the history information including dates and times of visits.

10. The outdoor apparatus according to claim 9, wherein the date and time of the visit comprises when the history information of the person corresponding to the voice input by the doorphone unit is displayed on the display.

11. The outdoor apparatus according to claim 7, wherein the memory stores response history regarding whether a response was made to a visit; and, when the speaker comparer determines that the voices are substantially equal, the controller further displays, on the display, the history information including the response history.

12. The outdoor apparatus according to claim 7, wherein the memory stores a feature parameter obtained from a voice input by the outdoor apparatus; and the speaker comparer compares a feature parameter obtained from a voice input by the outdoor apparatus with the feature parameter stored in the memory.

13. A method for controlling an indoor apparatus, the indoor apparatus communicating with an outdoor apparatus for an intercom system, the method comprising:
displaying an image captured by the outdoor unit, the outdoor unit including a camera;
storing, in a memory, an image of a person and history information related to the person;
comparing the image captured by the outdoor unit with the image of the person stored in the memory; and
displaying, on the display, the captured image and the history information related to the person, when it is determined that the image captured by the outdoor unit is substantially equal to the image of the person stored in the memory.

14. A method for controlling an indoor apparatus, the indoor apparatus communicating with an outdoor apparatus for an intercom system, the method comprising:
displaying history information of a person corresponding to a voice input by the outdoor apparatus, the outdoor apparatus including a microphone;
outputting, via a speaker, the voice input by the outdoor apparatus;
storing, in a memory, a voice of a person and history information related to the person;
comparing the voice input by the outdoor apparatus with the voice stored in the memory; and
displaying, on the display, the history information related to the person corresponding to a voice input by the outdoor apparatus, when it is determined that the voices are substantially equal.
